(19) United States
(12) Patent Application Publication
(10) Pub. No.: US 2016/0025070 A1
(43) Pub. Date: Jan. 28, 2016

(54) METHOD FOR CALCULATING THEORETICAL POWER OF A WIND FARM BASED ON EXTRAPOLATION OF ANEMOMETER TOWER DATA

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); MING MA, Beijing (CN); QING-QUAN LV, Beijing (CN); YAN-HONG MA, Beijing (CN); GUANG-TU LIU, Beijing (CN); HUAI-SEN JIA, Beijing (CN); LONG ZHAO, Beijing (CN); ZI-FEN HAN, Beijing (CN); QIANG ZHOU, Beijing (CN); DING-MEI WANG, Beijing (CN); LIANG LU, Beijing (CN); JIAN-MEI ZHANG, Beijing (CN)

(21) Appl. No.: 14/809,282

(22) Filed: Jul. 27, 2015

(30) Foreign Application Priority Data
Jul. 28, 2014 (CN) 201410362935.4

(51) Int. Cl. F03D 11/00; G01W 1/10

(52) U.S. Cl. CPC F03D 11/0091; G01W 1/10

(57) ABSTRACT

A method of calculating theoretical power of wind farm based on extrapolation of anemometer tower data includes following steps. A number of anemometer towers in a wind farm is selected, and analyzing historical data acquired by the number of anemometer towers. An air density is calculated based on the historical data of the number of anemometer towers. A power curve is calibrated based on the historical data of the number of anemometer towers. The power curve is fit based on a wind speed and a wind power of a fan head of each wind turbine based on the historical data. An theoretical power calculation extrapolation model of anemometer tower data is constructed. Real-time anemometer tower wind data and a calibrated air density are inputted into the theoretical power calculation model and calculating the wind power. The theoretical power is obtained.

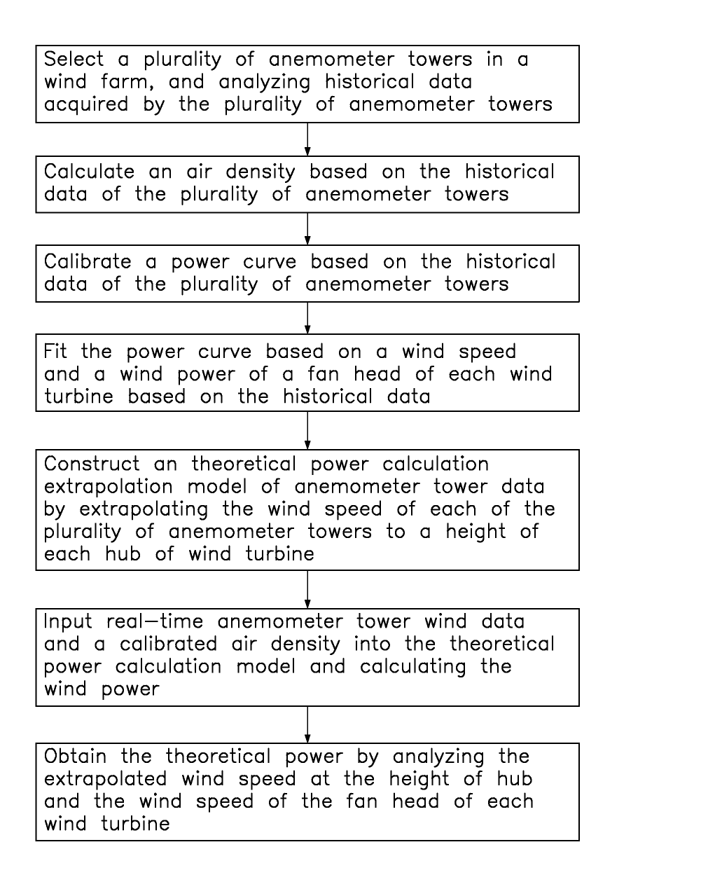

This application claims all benefits accruing under 35 U.S.C. §119 from China Patent Application 201410362935.4, filed on Jul. 28, 2014, in the China Intellectual Property Office, disclosure of which is incorporated herein by reference.

### BACKGROUND

1. Technical Field

The present disclosure relates to a method of calculating theoretical power of wind farm based on extrapolation of anemometer tower data.

2. Description of the Related Art

With the rapid development of wind power industry, China has entered a period of rapidly developing wind power. Large-scale wind power bases are usually located in the “Three North” (Northwest, Northeast, Northern China) of China.

On Jan. 1, 2006, “Renewable Energy Law” is promulgated and provides guarantee and new impetus for the development of wind power. China wind power has entered a phase of large-scale development, and “building large bases and access to a large grid” has become the main mode of development of wind power. By the end of 2012, China total installed capacity is about 75324.2MW, accounting for 26.7% of the world, and ranking the first in the world.

Large-scale wind power gives a great deal of pressure to the peak load regulation. Because of the limitation of peaking capacity and grid structure, a plurality of wind power bases abandon wind power and ration power. At present, the wind power network in particular wind power abandonment and wind power ration have become the focus of attention. The calculation of theoretical power and electric energy of the wind farm, and assessing abandoned wind power, has important significance to the contradiction between network and plant, and promote the sound development of the wind power industry.

The Wind Farm theory refers to the maximum power output under actual wind speed, and considering wake effects, downtime, plant consumption, transmission losses, and other factors. Due to large-scale wind power centralized and network, long-distance transport, high voltage requirement, China wind power shows significant difference over the foreign wind power development mode. The grid technology and economic problems is more complex. Most wind power base at remoteness district experiences sent bottlenecks, and the power ration is a serious problem. Because the power of wind farms can not be accurately predicted, thus the efficiency of wind power is low, and result other issues such as impact on the grid.

With development of new energy, uncertainty and uncontrollability of wind power and photovoltaic brings to many problems to the security and stability of economic operation of the grid. The wind power predication is the basis for large-scale wind power optimization scheduling. The wind power predication can provide critical information for real-time scheduling of new energy, recent plan of new energy, monthly plan of new energy, generation capacity of new energy, and abandoned wind power

What is needed, therefore, is a method of calculating theoretical power of wind farm.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

The only FIGURE shows a flowchart of one embodiment of flow chart of a method of calculating theoretical power of wind farm based on extrapolation of anemometer tower data.

### DETAILED DESCRIPTION

The disclosure is illustrated by way of example and not by way of limitation in the FIGURES of the accompanying drawings in which like references indicate similar elements. It should be noted that references to “an” or “one” embodiment in this disclosure are not necessarily to the same embodiment, and such references mean at least one.

Referring to the FIGURE, one embodiment of a method of calculating theoretical power of wind farm based on extrapolation of anemometer tower data comprises:

first step, selecting a plurality of anemometer towers in a wind farm, and analyzing historical data acquired by the plurality of anemometer towers;

second step, calculating an air density based on the historical data of the plurality of anemometer towers;

third step, calibrating a power curve based on the historical data of the plurality of anemometer towers;

fourth step, fitting the power curve based on wind speed and wind power of fan head of wind turbines based on the historical data;

fifth step, constructing a theoretical power calculation extrapolation model of anemometer tower data by extrapolating the wind speed of each of the plurality of anemometer towers to a height of each hub of wind turbine;

sixth step, inputting real-time anemometer tower wind data and calibrated air density into the theoretical power calculation model and calculating the wind power; and

seventh step, obtaining the theoretical power by analyzing the extrapolated wind speed at the height of hub and the wind speed of fan head of wind turbine.

In the second step, the air density can be calculated according to the historical data as follows:

$${ρ}_{i} = \frac{{B}_{i}}{{RT}_{i}} , \\ \overline{ρ} = \frac{1}{N} {\sum }_{i = 1}^{N} {ρ}_{i} ;$$

wherein ρᵢ is the instantaneous average air density, Bᵢ the instantaneous pressure, R is the gas constant 287.05 (J/kg·K). Tᵢ the average temperature, N is the number of samples, ρ̅ is the average air density.

In the third step, the power curve can be calibrated as follows:

while the as air density ranges within 1.225 kg/m³±0.05 kg/m₃, the power curve does not need to be calibrated; otherwise the power curve is calibrated as follows:

for the wind turbine with stall control, constant collective pitch, and constant speed, the power curve can be calibrated by following formula:

$${P}_{correct} = {P}_{0} \cdot \frac{\overline{ρ}}{{ρ}_{0}} ;$$

for the wind turbine with automatic power control, the power curve can be calibrated by following formula:

$${V}_{correct} = {{V}_{0} ( \frac{{ρ}_{0}}{\overline{ρ}} )}^{1 / 3} ;$$

wherein P_{correct} is the calibrated wind power; P₀ is the wind power according to theoretical power curve; ρ₀ is the standard air density; V₀ is the original wind speed; V_{correct} is the wind speed after the correction; ρ̅ is the measured average density.

In the fourth step, the power curve can be fit according to the wind speed and wind power of the fan head as follows:

the power curve can be fit according to method of bins; the wind speed is divided with a bin width of 0.5 m/s, and the wind power according to each bin can be obtained through:

$${P}_{i} = \frac{1}{{N}_{i}} {\sum }_{j = 1}^{{N}_{i}} {P}_{i , j} ;$$

$${V}_{i} = \frac{1}{{N}_{i}} {\sum }_{j = 1}^{{N}_{i}} {V}_{i , j} ;$$

wherein Pᵢ is the mean power value of the i-th bin, P_{i,j} is power value in j data group of the i-th bin, Vᵢ is the average value of the wind speed of the i-th bin, V_{i,j} is the wind speed in j data group of the i-th bin, Nᵢ is the quantity of the data in the i-th bin.

In the fifth step, the theoretical power calculation model can be constructed as follows:

considering the effect to the airflow field caused by the terrain, roughness changes, wake effects of wind turbine, and performance of wind turbine, and constructing a mapping relationship (the wind farm digital model) between the wind speed, the wind direction, and the output power of wind farm by combining wind farm layout;

constructing wind speed conversion function of each wind direction sector by extrapolating the wind speed of each of the plurality of anemometer towers to a height of each hub of wind turbine via adopting micro meteorology theory or fluid dynamics computation method:

Vₑₓₜᵣₐₚₒₗₐₜᵢₒₙ=ƒ(V_{anemometer tower}, k₁, k₂, . . . , kₙ);

wherein Vₑₓₜᵣₐₚₒₗₐₜᵢₒₙ is the wind speed while extrapolating the wind speed of each of the plurality of anemometer towers to a height of each hub of wind turbine; V_{anemometer tower} is the measured real-time wind speed of anemometer tower; k₁, k₂, . . . , kₙ are impact factors, ƒ is the conversion function;

constructing regression equation by adopting historical extrapolating wind speed and wind speed of fan head, and correcting the historical extrapolating wind speed;

computing theoretical power of each wind turbine by fitting the power curve according to the third step and the fourth step based on corrected historical extrapolating wind speed;

obtaining the theoretical power of wind farm by accumulating the theoretical power of each wind turbine in the wind farm.

### Embodiment

In order to calculated the theoretical power of wind farm, the method considers the effect to the airflow field caused by the terrain, roughness changes, wake effects of wind turbine, and performance of wind turbine, and constructing a mapping relationship (the wind farm digital model) between the wind speed, the wind direction, and the output power of wind farm by combining wind farm layout.

The method constructs the wind speed conversion function of each wind direction sector by extrapolating the wind speed of each of the plurality of anemometer towers to a height of each hub of wind turbine via adopting micro meteorology theory or fluid dynamics computation method.

The method computes theoretical power of each wind turbine by fitting the power curve and obtains the theoretical power of wind farm by accumulating the theoretical power of each wind turbine in the wind farm.

The method of embodiment comprises following steps.

(1) Calculating the Air Density.

The air density can be obtained by real-time measured temperature and pressure, and the average air density can be obtained by averaging the air density point by point:

$${ρ}_{i} = \frac{{B}_{i}}{{RT}_{i}} , \\ \overline{ρ} = \frac{1}{N} {\sum }_{i = 1}^{N} {ρ}_{i} ;$$

wherein ρᵢ is the instantaneous average air density, Bᵢ the instantaneous pressure, R is the gas constant 287.05 (J/kg·K). Tᵢ the average temperature, N is the number of samples, ρ̅ is the average air density.

(2) Calibrating the Power Curve.

The power curve of wind turbine should be verified and corrected before applied. While the power curve of wind turbine has been verified by experiments, and the real-time measured air density ranges within 1.225 kg/m³±0.05 kg/m₃, the power curve does not need to be calibrated; otherwise the power curve is calibrated as follows:

for the wind turbine with stall control, constant collective pitch, and constant speed, the power curve can be calibrated by following formula:

$${P}_{correct} = {P}_{0} \cdot \frac{\overline{ρ}}{{ρ}_{0}} ;$$

for the wind turbine with automatic power control, the power curve can be calibrated by following formula:

$${V}_{correct} = {{V}_{0} ( \frac{{ρ}_{0}}{\overline{ρ}} )}^{1 / 3} ;$$

wherein P_{correct} is the calibrated wind power; P₀ is the wind power according to theoretical power curve; ρ₀ is the standard air density; V₀ is the original wind speed; V_{correct} is the wind speed after the correction; ρ̅ is the measured average density.

(3) Fitting the Power Curve.

While the power curve of wind turbine has not been verified by experiments, the power curve can be fit according to the wind speed and wind power of the fan head. It is better to take average data in 5 minutes, and the data during unit failure and human-controlled period should be excluded.

The power curve can be fit according to method of bins. The wind speed is divided with a bin width of 0.5 m/s, and the wind power according to each bin can be obtained through:

$${P}_{i} = \frac{1}{{N}_{i}} {\sum }_{j = 1}^{{N}_{i}} {P}_{i , j} ;$$

$${V}_{i} = \frac{1}{{N}_{i}} {\sum }_{j = 1}^{{N}_{i}} {V}_{i , j} ;$$

wherein Pᵢ is the mean power value of the i-th bin, P_{i,j} is power value in j data group of the i-th bin, Vᵢ is the average value of the wind speed of the i-th bin, V_{i,j} is the wind speed in j data group of the i-th bin, Nᵢ is the quantity of the data in the i-th bin.

(4) Reducing the Theoretical Power.

The effect to the airflow field caused by the terrain, roughness changes, wake effects of wind turbine, and performance of wind turbine is considered, and a mapping relationship (the wind farm digital model) between the wind speed, the wind direction, and the output power of wind farm by combining wind farm layout is constructed.

The wind speed conversion function of each wind direction sector is constructed by extrapolating the wind speed of each of the plurality of anemometer towers to a height of each hub of wind turbine via adopting micro meteorology theory or fluid dynamics computation method:

Vₑₓₜᵣₐₚₒₗₐₜᵢₒₙ=ƒ(V_{anemometer tower}, k₁, k₂, . . . , kₙ);

wherein Vₑₓₜᵣₐₚₒₗₐₜᵢₒₙ is the wind speed while extrapolating the wind speed of each of the plurality of anemometer towers to a height of each hub of wind turbine; V_{anemometer tower} is the measured real-time wind speed of anemometer tower; k₁, k₂, . . . , kₙ are impact factors, ƒ is the conversion function.

The regression equation is constructed by adopting historical extrapolating wind speed and wind speed of fan head, and corrects the historical extrapolating wind speed. The theoretical power of each wind turbine is computed by fitting the power curve according to the third step and the fourth step based on corrected historical extrapolating wind speed. The theoretical power of wind farm is obtained by accumulating the theoretical power of each wind turbine in the wind farm.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of calculating theoretical power of wind farm based on extrapolation of anemometer tower data, the method comprising:
selecting a plurality of anemometer towers in a wind farm, and analyzing historical data acquired by the plurality of anemometer towers;
calculating an air density based on the historical data of the plurality of anemometer towers;
calibrating a power curve based on the historical data of the plurality of anemometer towers;
fitting the power curve based on a wind speed and a wind power of a fan head of each wind turbine based on the historical data;
constructing a theoretical power calculation extrapolation model of anemometer tower data by extrapolating the wind speed of each of the plurality of anemometer towers to a height of each hub of the wind turbine;
inputting real-time anemometer tower wind data and a calibrated air density into the theoretical power calculation model and calculating the wind power; and
obtaining the theoretical power by analyzing the extrapolated wind speed at the height of hub and the wind speed of the fan head of each wind turbine.

2. The method of claim 1, wherein the air density is calculated according to the historical data as follows:
$${ρ}_{i} = \frac{{B}_{i}}{{RT}_{i}} , \\ \overline{ρ} = \frac{1}{N} {\sum }_{i = 1}^{N} {ρ}_{i} ;$$
wherein ρᵢ is the instantaneous average air density, Bᵢ is the instantaneous pressure, R is the gas constant 287.05 (J/kg·K). Tᵢ is the average temperature, N is the number of samples, ρ̅ is the average air density.

3. The method of claim 1, wherein the power curve is calibrated as follows:
while the air density ranges within 1.225 kg/m³±0.05 kg/m₃, the power curve does not need to be calibrated; otherwise the power curve is calibrated as follows:
for the wind turbine with stall control, constant collective pitch, and constant speed, the power curve is calibrated by following formula:
$${P}_{correct} = {P}_{0} \cdot \frac{\overline{ρ}}{{ρ}_{0}} ;$$
for the wind turbine with automatic power control, the power curve is calibrated by following formula:
$${V}_{correct} = {{V}_{0} ( \frac{{ρ}_{0}}{\overline{ρ}} )}^{1 / 3} ;$$
wherein P_{correct} is the calibrated wind power; P₀ is the wind power according to theoretical power curve; ρ₀ is the standard air density; V₀ is the original wind speed; V_{correct} is the wind speed after the correction; ρ̅ is the measured average density.

4. The method of claim 3, wherein the power curve is fit according to the wind speed and the wind power of the fan head as follows:
the power curve is fit according to method of bins; the wind speed is divided with a bin width of 0.5 m/s, and the wind power according to each bin is obtained through:
$${P}_{i} = \frac{1}{{N}_{i}} {\sum }_{j = 1}^{{N}_{i}} {P}_{i , j} ;$$
$${V}_{i} = \frac{1}{{N}_{i}} {\sum }_{j = 1}^{{N}_{i}} {V}_{i , j} ;$$
wherein Pᵢ is the mean power value of the i-th bin, P_{i,j} is power value in j data group of the i-th bin, Vᵢ is the average value of the wind speed of the i-th bin, V_{i,j} is the wind speed in j data group of the i-th bin, Nᵢ is the quantity of the data in the i-th bin.

5. The method of claim 4, wherein the theoretical power calculation model is constructed as follows:
considering an effect to the airflow field caused by terrain, roughness changes, wake effects of wind turbine, and performance of wind turbine, and constructing a mapping relationship between the wind speed, the wind direction, and the output power of wind farm by combining wind farm layout;
constructing wind speed conversion function of each wind direction sector by extrapolating the wind speed of each of the plurality of anemometer towers to a height of each hub of wind turbine via adopting micro meteorology theory or fluid dynamics computation method:
Vₑₓₜᵣₐₚₒₗₐₜᵢₒₙ=ƒ(V_{anemometer tower}, k₁, k₂, . . . , kₙ);
wherein Vₑₓₜᵣₐₚₒₗₐₜᵢₒₙ is the wind speed while extrapolating the wind speed of each of the plurality of anemometer towers to a height of each hub of wind turbine; V_{anemometer tower} is the measured real-time wind speed of anemometer tower; k₁, k₂, . . . , kₙ are impact factors, ƒ is the conversion function;
constructing regression equation by adopting historical extrapolating wind speed and wind speed of fan head, and correcting the historical extrapolating wind speed;
computing theoretical power of each wind turbine by fitting the power curve according to the third step and the fourth step based on corrected historical extrapolating wind speed; and
obtaining the theoretical power of wind farm by accumulating the theoretical power of each wind turbine in the wind farm.
